(19) United States
(12) Patent Application Publication
(10) Pub. No.: US 2009/0249047 A1
(43) Pub. Date: Oct. 1, 2009

(54) METHOD AND SYSTEM FOR RELATIVE MULTIPLE-TARGET BRANCH INSTRUCTION EXECUTION IN A PROCESSOR

(75) Inventor: Daniel Citron, Haifa (IL)

Correspondence Address: IBM-ACC-Washington;c/o Myers Dawes Andras & Sherman, LLP, 19900 MacArthur Blvd., 11th Floor, Irvine, CA, 92612, US

(73) Assignee: International Business Machines Corporation, Armonk, NY (US)

(21) Appl. No.: 12/059,957

(22) Filed: Mar. 31, 2008

(51) Int. Cl. G06F 9/30

(52) U.S. Cl. 712/236; 712/E09.016

(57) ABSTRACT

A method and system for relative multiple-target branch instruction execution in a processor is provided. One implementation involves receiving an instruction for execution; determining a next instruction to execute based on multiple condition bits or outcomes of a comparison by the current instruction; obtaining a specified instruction offset in the current instruction; and using the offset as the basis for multiple instruction targets based on said outcomes, wherein the number of conditional branches is reduced.

### BACKGROUND OF THE INVENTION

1. Field of the Invention

The present invention relates generally to instruction execution and in particular to conditional branch instruction execution.

2. Background Information

Conditional branch instructions direct the processor to continue execution from the next instruction (fall through) or from the address specified in the instruction itself or in a register (target). However, a branch is simply a binary decision based on a single bit, set in a previous or the current instruction, to a single target.

There are conventional approaches for multiple branch targets for an instruction. Such conventional approaches, however, involve using an array of registers to hold such targets. Such approaches cause unnecessary program code size due to setting multiple targets, which leads to a shortage of General Purpose (GP) registers, which in turn lead to register spill to memory. Such approaches also cause larger instructions due to the need to map more registers in an instruction. Further, an additional dedicated array of target registers is needed.

### SUMMARY OF THE INVENTION

The invention provides a method and system for relative multiple-target branch instruction execution in a processor. One embodiment involves receiving a multiple-target branch instruction for execution; determining a next instruction to execute based on multiple condition bits or outcomes of a comparison by the current instruction; obtaining a specified instruction offset in the current instruction; and using the offset as the basis for multiple instruction targets based on said outcomes, wherein the number of conditional branches is reduced.

Other aspects and advantages of the present invention will become apparent from the following detailed description, which, when taken in conjunction with the drawings, illustrate by way of example the principles of the invention.

### BRIEF DESCRIPTION OF THE DRAWINGS

For a fuller understanding of the nature and advantages of the invention, as well as a preferred mode of use, reference should be made to the following detailed description read in conjunction with the accompanying drawings, in which:

FIG. 1 shows a typical branch code instruction.

FIG. 2 shows a multiple-target branch instruction, according to an embodiment of the invention.

FIG. 3 shows a multiple-target branch instruction, according to another embodiment of the invention.

FIG. 4 shows a process of multiple-target branch instruction execution on a processor, according to an embodiment of the invention.

FIG. 5 shows a compiler generating multiple-target branch instruction code, according to an embodiment of the invention.

### DESCRIPTION OF THE PREFERRED EMBODIMENTS

The following description is made for the purpose of illustrating the general principles of the invention and is not meant to limit the inventive concepts claimed herein. Further, particular features described herein can be used in combination with other described features in each of the various possible combinations and permutations. Unless otherwise specifically defined herein, all terms are to be given their broadest possible interpretation including meanings implied from the specification as well as meanings understood by those skilled in the art and/or as defined in dictionaries, treatises, etc.

The invention provides a method and system for multiple target branches based on only one specified offset in a program/code instruction. A multiple-branch determines the target based on more than 1 condition bit or on the several outcomes of a comparison (equal, larger, smaller). For example, an instruction that is based on 2 condition bits has four different outcomes. This reduces at least 2 branch instructions. The specified offset is used as the basis for multiple targets. If a branch instruction is based on two condition bits, the possible outcomes are:

00—fall-through to next instruction.

01—branch to current address+offset.

10—branch to current address−offset*2.

11—branch to current address+offset*2.

The bits 00, 01, 10 and 11 show the four possibilities for the two condition bits; each having values 0 or 1.

The advantages of such a technique include less conditional branches being executed (leading to faster code execution) and less GP registers being used to hold comparison values, condition bits, or branch targets. Further, no dedicated arrays of branch targets are needed.

A first example is described below. The following high level instruction C programming language code in Table I sets the value of a based on the values of b and c.

TABLE I

```
  if(b > 0)
    if(c > 0)
      a = b/c;
    else
      a = b*c;
  else
    if(c >0)
      a = b + c;
    else
      a = b − c;
printf(“%d\n”, a).
```

The corresponding assembly code generated by a compiler (Power5 processor (GCC 4.1.1 with -O3) is shown in Table II below.

TABLE II

| | | |
|---|---|---|
| 1 | [symbol] | ;compare b to 0 |
| 2 | [symbol] | ;compare c to 0 |
| 3 | add 4,31,3 | ;a=b+c |
| 4 | ble 7,.L2 | ;if b < 0 branch to L2 for further comparisons |
| 5 | mullw 4,31,3 | ;a=b*c |
| 6 | ble 1,.printf | ;if c < 0 and b > 0 branch and print a=b*c |
| 7 | divw 4,31,3 | ;a=b/c |
| 8 | b .printf | ;else both b > 0 and c > 0 print a=b/c |
| 9 | .L2: | |
| 10 | bgt 1,.printf | ;if c > 0 and b < 0 branch and print a=b+c |
| 11 | subf 4,3,31 | ; a=b−c |
| 12 | .printf: | |

In the above assembly code in Table II, the comparisons are based on only 2 condition bits (bold italic code lines 1, 2). The bold code lines (bold non-italic code lines 4, 6, 10) are conditional branches, three of which are generated by the compiler, and at least two are executed through any given path. Since the comparisons are based on only two condition bits, a multiple target branch instruction according to the invention can eliminate the need for the three static and two dynamic conditional branches, as described below.

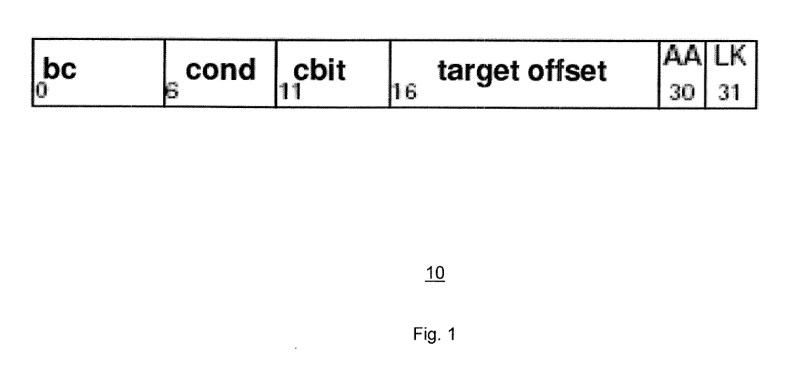

FIG. 1 shows a typical conditional branch instruction 10 in the Power architecture. The 5-bit condition field (cond) defines how to interpret the condition bit (cbit field), a bit in a condition register (CR) of the Power architecture. If the condition is true, execution continues at target offset+the branch instruction address. If the condition is false, the next (fall-through) instruction is executed. Examples of the cond field include branch if the cbit=1, or branch if the cbit=0 (most other possibilities deal with the CTR register, a Power architecture specific register that can be ignored in this embodiment).

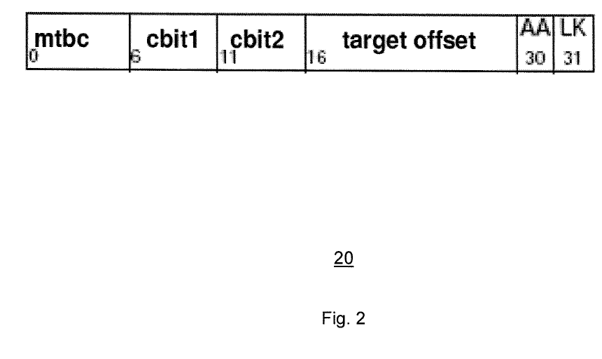

Referring to FIG. 2, in a multiple-target branch (named mtbc) 20 according to an embodiment of the invention, the cond field can be replaced by a second cbit field, wherein the multiple-target branch has two cbit fields' cbit1 and cbit2. And its functionality based on the values of cbit1 and cbit2 is:

00—fall-through to next instruction.

01—branch to current address+target offset.

10—branch to current address−target offset*2.

11—branch to current address+target offset*2.

The bits 00, 01, 10 and 11 show the four possibilities for the two condition bits cbit1 and cbit2, each having values 0 or 1.

A second version of assembly code for the code in Table I is shown in Table III below, wherein multiple-branch instruction is generated in the assembly code by the compiler based on the multiple-target branch instruction in FIG. 2, according to the invention.

TABLE III

| | |
|---|---|
| 1 | .−tgt2: mullw 4,31,3 ; −6 instructions from branch |
| 2 | b .printf |
| 3 | nop |
| 4 | [symbol] |
| 5 | [symbol] |
| 6 | subf 4,3,31 |
| 7 | mwbc 7,1,.tgt |
| 8 | b .printf |
| 9 | nop |
| 10 | .tgt: add 4,31,3 ; 3 instructions away from branch |
| 11 | b .printf |
| 12 | nop |
| 13 | .tgt2: divw 4,31,3 ; 6 instructions away branch |
| 14 | .printf:... |

Only one branch instruction is needed. Specifically, the comparisons are based on only 2 condition bits (bold italic code lines 4, 5) in Table III. The bold code line (bold non-italic code line 7) is a conditional branch, one of which is generated. The number of conditional branches has been reduced to 1, compared to that in Table II. Although several no-operation (nop) instructions have been added for padding, they are not in the execution path.

Another multi-branch instruction embodiment based on the values of two condition bits is:

00—fall-through to next instruction

01—branch to current address+target offset*1

10—branch to current address+target offset*2

11—branch to current address+target offset*3

wherein the compiler generates assembly code as in Table IV below.

TABLE IV

| | |
|---|---|
| [symbol] | |
| [symbol] | |
| subf 4,3,31 | |
| mwbc 7,1,.tgt | |
| b .printf | |
| .tgt: add 4,31,3 | ; 2 instructions away from branch |
| b .printf | |
| .tgt2: divw 4,31,3 | ; 4 instructions away from branch |
| b .printf | |
| .tgt3: mullw 4,31,3 | ; 6 instructions away from branch |
| .printf:... | |

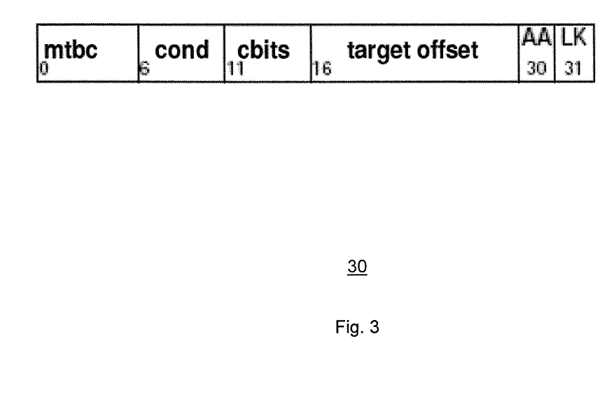

FIG. 3 shows another embodiment of a multiple-target branch 30 according to the invention, wherein the cbit field addresses two or more consecutive condition bits and that the cond field determines how to branch (i.e., fall-through if all are 0, +target if all are 1, −target if only one cbit is 1, etc.).

In other instruction set architectures, such as Microprocessor without Interlocked Pipeline Stages or MIPS for example, the branch instruction performs the comparison and branch in the same instruction, as shown by example in Table V below.

TABLE V

| branch on | beq | if ($1 == $2) go to | Equal test; PC relative |
|---|---|---|---|
| equal | $1,$2,100 | PC + 4 + 100 | branch |
| branch on not | bne | if ($1 != $2) go to | Not equal test; PC |
| equal | $1,$2,100 | PC + 4 + 100 | relative |

An example corresponding multi-target branch instruction (bcmp) for Table V according to the invention, represented as bcmp $1, $2,100, comprises:

a==b—fall-through to next instruction.

a>b—branch to instruction+100.

a<b—branch to instruction−100.

Then the following C code translates to code in Table VI (further below) based on multi-target branch instruction bcmp:

if(a == b){
foo(a);
}
else{
if (a > b){
foo(b);
}
else{
foo(a+b);
}
}

TABLE VI
Code based on multi-target branch instruction bcmp

−L1: call foo(a+b) ; when a < b
...
bcmp $1,$2,L1
call foo(a) ; when a == b
...
L1: call foo(b) ; when a > b

Alternative implementations can reduce the number of nops. The invention can be implemented such as in embedded processors and applications where minimizing code size is important. The compiler performs analysis in order to make use of the new multiple-target instruction branches.

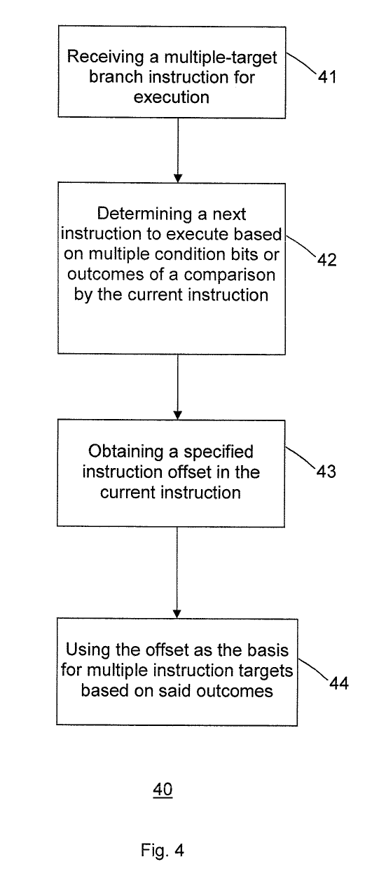

FIG. 4 shows an example process 40 for relative multiple-target branch instruction execution in a processor, including:
Block 41: Receiving a multiple-target branch instruction for execution;
Block 42: Determining a next instruction to execute based on multiple condition bits or outcomes of a comparison by the current instruction;
Block 43: Obtaining a specified instruction offset in the current instruction; and
Block 44: Using the offset as the basis for multiple instruction targets based on said outcomes, wherein the number of conditional branches is reduced.

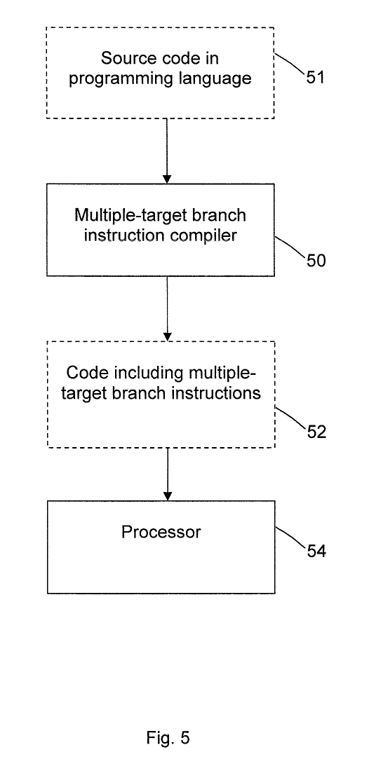

FIG. 5 shows an example compiler 50 for receiving programming language text 51 (e.g., source code in C language text) and generating code 52 with multiple-target branch instructions, embodying the present invention. The compiler can be implemented as one or more software modules that translate text 51 into another computer language (e.g., assembly code, object code) suitable for processing by other programs (e.g., a linker) or executable instructions for a processor 54 (CPU). The compiler may include a lexical analyzer, a parser and a code generator for generating the code 52, which may be machine code.

As is known to those skilled in the art, the aforementioned example embodiments described above, according to the present invention, can be implemented in many ways, such as program instructions for execution by a processor, as software modules, as computer program product on computer readable media, as logic circuits, as silicon wafers, as integrated circuits, as application specific integrated circuits, as firmware, etc. Though the present invention has been described with reference to certain versions thereof, however, other versions are possible. Therefore, the spirit and scope of the appended claims should not be limited to the description of the preferred versions contained herein.

Those skilled in the art will appreciate that various adaptations and modifications of the just-described preferred embodiments can be configured without departing from the scope and spirit of the invention. Therefore, it is to be understood that, within the scope of the appended claims, the invention may be practiced other than as specifically described herein.

What is claimed is:

1. A method for relative multiple-target branch instruction execution in a processor, comprising:
receiving a multiple-target branch instruction for execution;
determining a next instruction to execute based on multiple condition bits or outcomes of a comparison by the current instruction;
obtaining a specified instruction offset in the current instruction; and
using the offset as the basis for multiple instruction targets based on said outcomes, wherein the number of conditional branches is reduced.
